(19) United States
(12) Patent Application Publication
(10) Pub. No.: US 2021/0362654 A1
(43) Pub. Date: Nov. 25, 2021

(54) IMAGE DISPLAY DEVICE

(71) Applicant: TOYOTA JIDOSHA KABUSHIKI KAISHA, Toyota-shi (JP)

(72) Inventors: Tomoaki IIDA, Okazaki-shi (JP); Jumpei INAGAKI, Toyota-shi (JP); Yosuke KUBOTA, Toyota-shi (JP); Tomohito HIGUMA, Toyota-shi (JP)

(21) Appl. No.: 17/243,658

(22) Filed: Apr. 29, 2021

(30) Foreign Application Priority Data
May 19, 2020 (JP) 2020-087662

(51) Int. Cl. B60R 1/08; B60R 1/12

(52) U.S. Cl. CPC B60R 1/08; B60R 1/12; B60R 2300/306; B60R 2300/8046; B60R 2001/1215

(57) ABSTRACT

An image display device has an electronic inner mirror, a driver monitoring system, and a display control device. The electronic inner mirror is provided within a vehicle cabin, and enables display of an image within an image displayable region. The driver monitoring system acquires a viewpoint position of a vehicle occupant who views the electronic inner mirror. In accordance with the viewpoint position of the vehicle occupant acquired by the driver monitoring system, the display control device carries out image processing so as to change a displayed position of the image within the image displayable region of the electronic inner mirror.

### CROSS-REFERENCE TO RELATED APPLICATION

This application is based on and claims priority under 35 USC 119 from Japanese Patent Application No. 2020-087662 filed on May 19, 2020, the disclosure of which is incorporated by reference herein.

### BACKGROUND

### Technical Field

The present disclosure relates to an image display device.

### Related Art

Japanese Patent Application Laid-Open (JP-A) No. 2006-51850 (Patent Document 1) that is described hereinafter discloses an invention relating to a drive assist device. In this drive assist device, cameras that are installed at a vehicle capture images of the rear lateral sides of the vehicle, and an image processing section generates, in the images obtained by the cameras, guide lines for assisting driving, and displays an image on a monitor.

However, in the case of the structure disclosed in Patent Document 1, depending on the position of the viewpoint of the vehicle occupant who is viewing the monitor, there is the possibility that the image displayed on the monitor and a member, which is disposed at the periphery of the monitor such as the frame member of the monitor or the like (hereinafter simply called “obstacle to viewing”), will overlap, and the vehicle occupant will not be able to view the image properly. Accordingly, in the above-described related art, there is room for improvement with regard to these points.

### SUMMARY

In view of the above-described circumstances, an object of the present disclosure is to provide an image display device that can improve visibility.

An image display device relating to a first aspect has: displaying means that is provided within a vehicle cabin, and enables display of an image within an image displayable region; viewpoint position acquiring means for acquiring a viewpoint position of a vehicle occupant who views the displaying means; and display controlling means for carrying out image processing so as to, in accordance with the viewpoint position of the vehicle occupant acquired by the viewpoint position acquiring means, change at least one of a displayed position of the image within the image displayable region of the displaying means, and a cutting-out position of the image at a time of cutting-out a portion of the image and displaying on the displaying means.

In accordance with the first aspect, the image display device has displaying means, viewpoint position acquiring means, and display controlling means. The displaying means is provided within the vehicle cabin, and enables display of an image within the image displayable region. The viewpoint position acquiring means acquires the viewpoint position of the vehicle occupant who views the displaying means. In accordance with the viewpoint position of the vehicle occupant that is acquired by the viewpoint position acquiring means, the display controlling means carries out image processing so as to change at least one of the displayed position of the image within the image displayable region of the displaying means, and the cutting-out position of the image at a time of cutting-out a portion of the image and displaying on the displaying means. Accordingly, in a case in which it is supposed that the image is being viewed in a manner of overlapping an obstacle to viewing due to the viewpoint position of the vehicle occupant, the displayed position of the image can be changed to a position of not overlapping the obstacle to viewing, or the cutting-out position can be changed such that highly-important information is not displayed at a region that overlaps an obstacle to viewing in the image.

In an image display device relating to a second aspect, in the first aspect, the display controlling means carries out image processing of the image that is acquired from imaging means that captures images of a periphery of the vehicle.

In accordance with the second aspect, the display controlling means carries out image processing on the image that is acquired from an imaging means that captures images of the periphery of the vehicle. Therefore, the vehicle occupant can see an image, which shows the situation at the periphery of the vehicle that is important at the time of driving, without the image being blocked by an obstacle to viewing.

In an image display device relating to a third aspect, in the first or second aspect, the displaying means displays at least a portion of the image as a virtual image.

In accordance with the third aspect, the displaying means displays at least a portion of the image as a virtual image. Therefore, fluctuations in the focal length between the time when the image that is a virtual image of the displaying means is viewed, and the time when the front side in the traveling direction is viewed, are suppressed, and the burden on the vehicle occupant at the time of viewing can be reduced. Further, at the displaying means that displays the virtual image, generally, the virtual image can be seen by peering into the housing. Namely, depending on the viewpoint position of the vehicle occupant, there is the possibility that the housing will become an obstacle to viewing, and the image that is a virtual image will not be able to be seen. However, in the image display device of the present invention, in a case in which it is supposed that the image will be seen in a manner of overlapping with an obstacle to viewing due to the viewpoint position of the vehicle occupant, the displayed position of the image can be changed to a position of not overlapping the housing, or the cutting-out position can be changed such that highly-important information is not displayed at a region that overlaps the housing in the image.

In an image display device relating to a fourth aspect, in any one of the first through third aspects, the display controlling means changes a display magnification at which the image is displayed in an enlarged manner, in accordance with the viewpoint position of the vehicle occupant acquired by the viewpoint position acquiring means.

In accordance with the fourth aspect, the display controlling means changes the display magnification at which the image is displayed in an enlarged manner, in accordance with the viewpoint position of the vehicle occupant that is acquired by the viewpoint position acquiring means. Accordingly, depending on the viewpoint position, there are cases in which the image is seen to be smaller than in a case in which the image is viewed when faced directly. However, in such cases, by changing the display magnification of the image, the size of the image when viewed can be made to be substantially constant, regardless of the viewpoint position.

The image display device relating to the first aspect can improve the visibility.

The image display device relating to the second aspect can assist safe driving.

The image display device relating to the third aspect can improve the visibility while reducing the burden on the vehicle occupant.

The image display device relating to the fourth aspect can improve the visibility more.

### BRIEF DESCRIPTION OF THE DRAWINGS

FIG. 1 is a schematic perspective view showing a state in which a vehicle cabin interior of a vehicle, which has an image display device relating to a first embodiment, is viewed facing the vehicle front side.

FIG. 2 is a block drawing showing hardware structures of the image display device relating to the first embodiment.

FIG. 3 is a block drawing showing functional structures of the image display device relating to the first embodiment.

FIG. 4 is a schematic perspective view that includes illustration of a portion of a housing of a displaying means of the image display device relating to the first embodiment.

FIG. 5 is a schematic drawing showing an example of a captured image that is outputted on the displaying means of the image display device relating to the first embodiment.

FIG. 6 is a schematic drawing showing an example of a captured image that is outputted on the displaying means in a case in which a viewpoint position of a vehicle occupant is at the upper right with respect to directly facing the displaying means, in contrast with FIG. 5.

FIG. 7 is a schematic drawing showing an example of a captured image that is outputted on the displaying means in a case in which the viewpoint position of the vehicle occupant is at the lower left with respect to directly facing the displaying means, in contrast with FIG. 5.

FIG. 8 is a schematic drawing showing the relationship in a case in which the viewpoint position of the vehicle occupant and the displaying means directly face one another in an image display device relating to a second embodiment.

FIG. 9 is a schematic drawing showing the relationship in a case in which the viewpoint position of the vehicle occupant is inclined with respect to a position of directly facing the displaying means in the image display device relating to the second embodiment.

FIG. 10 is a schematic drawing corresponding to FIG. 6, of the image display device relating to the second embodiment.

FIG. 11 is a schematic drawing showing an example of an image outputted on a displaying means of an image display device relating to a third embodiment.

FIG. 12 is a schematic drawing showing an example of a range of the captured image that is outputted on the displaying means in a case in which the viewpoint position of the vehicle occupant is at the upper right with respect to directly facing the displaying means, in contrast with FIG. 11.

### DETAILED DESCRIPTION

### First Embodiment

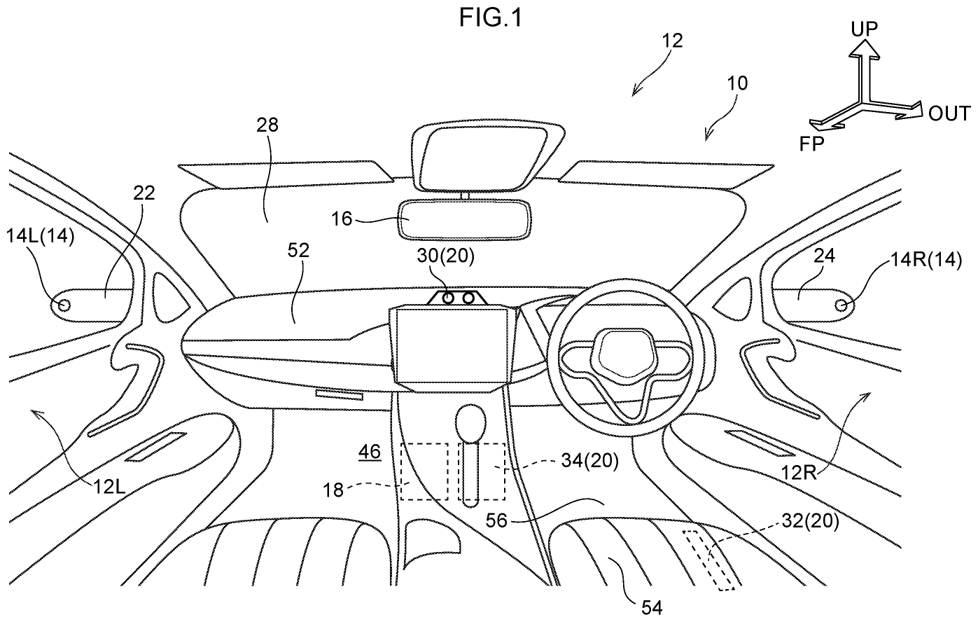

An image display device 10 relating to a first embodiment of the present invention is described hereinafter by using FIG. 1 through FIG. 7.

(Overall Structure)

As shown in FIG. 1, the image display device 10 has a camera unit that serves as imaging means that is installed in a vehicle 12, an electronic inner mirror 16 that serves as displaying means, a display control device 18, and a driver monitoring system 20 that serves as viewpoint position acquiring means.

The proximal portion of a camera supporting body 22, which is substantially parallelepiped and whose distal end portion is arc-shaped, is mounted to the vehicle front side end portion of a vehicle vertical direction intermediate portion of a left side door (front side door) 12L of the vehicle, such that the distal end portion of the camera supporting body 22 projects-out toward the vehicle outer side. A rear left lateral side camera 14L that structures a portion of a camera unit 14 is mounted to a vicinity of the distal end portion of the camera supporting body 22. The imaging optical axis (lens) of the rear left lateral side camera 14L faces toward the rear left side of the vehicle, and the rear left lateral side camera 14L captures images of some of the region at the left rear side and the left lateral side of the vehicle. The camera supporting body 22 can rotate in the vehicle longitudinal direction with the substantially vehicle vertical direction being the axial direction thereof, and, by the driving force of an unillustrated actuator, can be rotated to a stored position, at which the length direction of the camera supporting body 22 runs approximately along the outer side surface of the vehicle, or a returned position at which the rear left lateral side camera 14L images the rear left side of the vehicle. The concrete structure and operation of the rear left lateral side camera 14L are described later.

The proximal portion of a camera supporting body 24, which has a shape that has left-right symmetry with respect to that of the camera supporting body 22, is mounted to the vehicle front side end portion of a vehicle vertical direction intermediate portion of a right side door (front side door) 12R of the vehicle 12. A rear right lateral side camera 14R that structures another portion of the camera unit 14 is mounted to a vicinity of the distal end portion of the camera supporting body 24. The imaging optical axis (lens) of the rear right lateral side camera 14R faces toward the rear right side of the vehicle, and the rear right lateral side camera 14R captures images of some of the region at the right rear side and the right lateral side of the vehicle. The camera supporting body 24 also can rotate in the vehicle longitudinal direction with the substantially vehicle vertical direction being the axial direction thereof, and, by the driving force of an unillustrated actuator, can be rotated to a stored position, at which the length direction of the camera supporting body 24 runs approximately along the outer side surface of the vehicle, or a returned position at which the rear right lateral side camera 14R images the rear right side of the vehicle. The concrete structure and operation of the rear right lateral side camera 14R are described later.

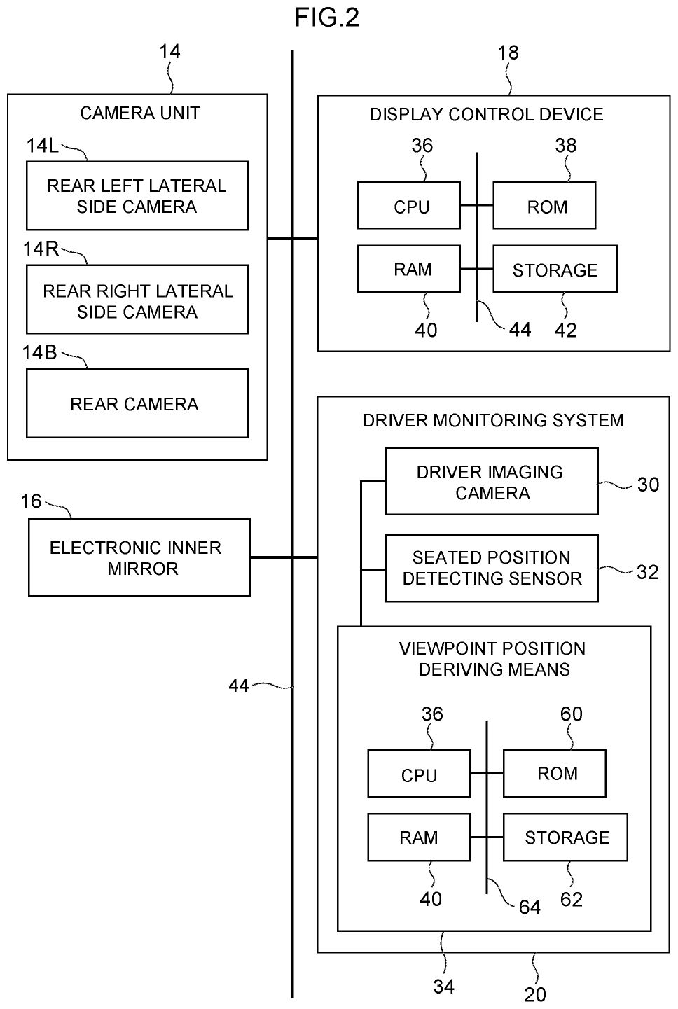

Moreover, a rear camera 14B (see FIG. 2) that structures a portion of the camera unit is mounted to an unillustrated trunk lid that is provided at the vehicle rear side of the vehicle 12. The imaging optical axis (lens) of the rear camera 14B faces toward the rear side of the vehicle, and the rear camera 14B captures images of the region at the rear of the vehicle 12. The concrete structure and operation of the rear camera 14B are described later.

The electronic inner mirror 16 is provided at the vehicle upper side and the vehicle transverse direction substantial center of a front windshield glass 28. The concrete structure and operation of the electronic inner mirror 16 are described later.

The display control device 18 is installed within the vehicle cabin, and is connected to the camera unit 14, the rear camera 14B, the electronic inner mirror 16, and the driver monitoring system 20 so as to be able to communicate therewith. The concrete structure and operation of the display control device 18 are described later.

The driver monitoring system 20 is installed in the vehicle cabin, and is structured to include a driver imaging camera 30, a seated position detecting sensor 32, and a viewpoint position deriving device 34. The concrete structure and operation of the driver monitoring system 20 are described later.

(Hardware Structures)

FIG. 2 is a block drawing showing hardware structures of the image display device 10.

As shown in FIG. 2, the image display device 10 is structured to include a CPU (Central Processing Unit) 36, a ROM (Read Only Memory) 38, a RAM (Random Access Memory) 40 and a storage 42 that are provided within the display control device 18, and the rear left lateral side camera 14L, the rear right lateral side camera 14R, the rear camera 14B, the electronic inner mirror 16, and the driver monitoring system 20. These respective structures are connected so as to be able to communicate with one another via a bus 44.

The CPU 36 is a central computing processing unit, and executes various programs and controls various sections. Namely, the CPU 36 reads-out programs from the ROM 38 or the storage 42, and executes the programs by using the RAM 40 as a workspace. The CPU 36 carries out control of the above-described respective structures and various computing processings in accordance with programs recorded in the ROM 38 or the storage 42. In the present embodiment, an image processing program, which carries out image processing on the image that is to be displayed on the electronic inner mirror 16, is stored in the ROM 38 or the storage 42.

The ROM 38 stores various programs and various data. The RAM 40 temporarily stores programs and data as a workspace. The storage 42 is structured by an HDD (Hard Disk Drive) or an SSD (Solid State Drive), and stores various programs including the operating system, and various data.

As an example, the rear left lateral side camera 14L does not have a mechanism that changes the direction of the imaging optical axis thereof, and has a fixed focus lens, and the image angle thereof is a relatively wide angle. Therefore, in the state in which the camera supporting body 22 is positioned at the returned position, the rear left lateral side camera 14L captures images over a relatively wide angle and in a given imaging range of the left rear side of the vehicle.

In the same way as the rear left lateral side camera 14L, as an example, the rear right lateral side camera 14R does not have a mechanism that changes the direction of the imaging optical axis thereof, and has a fixed focus lens, and the image angle thereof is a relatively wide angle. Therefore, in the state in which the camera supporting body 24 is positioned at the returned position, the rear right lateral side camera 14R captures images over a relatively wide angle and in a given imaging range of the right rear side of the vehicle.

As an example, the rear camera 14B does not have a mechanism that changes the direction of the imaging optical axis thereof, and has a fixed focus lens, and the image angle thereof is a relatively wide angle. Therefore, the rear camera 14B captures images over a relatively wide angle and in a given imaging range of the rear side of the vehicle 12.

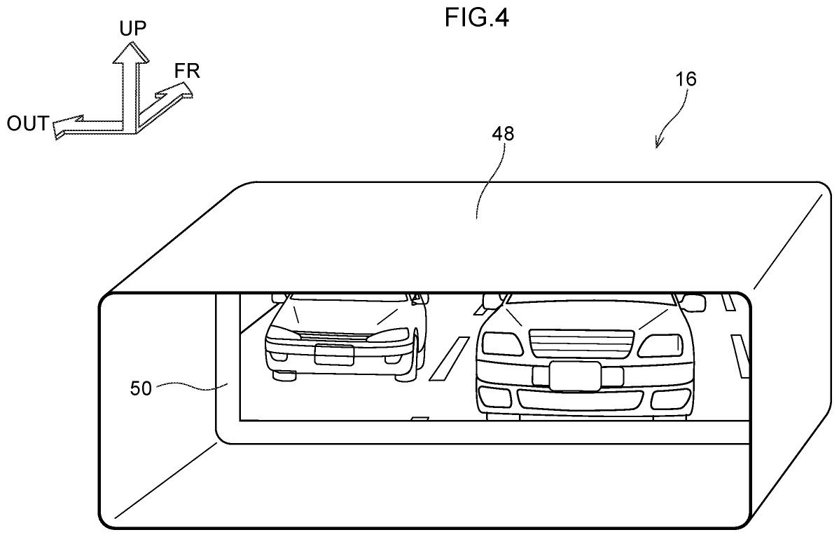

As shown in FIG. 1, the electronic inner mirror 16 can display images toward the inner side of a vehicle cabin 46. An image, in which the images captured by the rear camera 14B (see FIG. 2), the rear left lateral side camera 14L and the rear right lateral side camera 14R are subjected to image processing at the display control device 18 and are respectively merged together so as to be continuous, is displayed on the electronic inner mirror 16 within an image displayable region 50 that is provided at the interior of a housing 48 as shown in FIG. 4. Note that the electronic inner mirror 16 projects this image within the image displayable region 50 as a virtual image whose focal point is positioned further toward the vehicle front side than the image displayable region 50. Namely, the vehicle occupant can view the image of the virtual image by so-called peering-in into the interior of the housing 48. Due thereto, as compared with a case in which the vehicle occupant looks forward in the direction of traveling, the vehicle occupant can view the image that is displayed by the electronic inner mirror 16 while fluctuations in the focal length are suppressed, and, from this image, can confirm the situation at the periphery of the vehicle 12 which situation is centered around the rear of the vehicle.

As shown in FIG. 2, the driver imaging camera 30 of the driver monitoring system 20 is provided at the upper surface of an instrument panel 52 (see FIG. 1), and images the face of the vehicle occupant who is seated in the driver's seat, and acquires position information of the eyes of that vehicle occupant. The driver imaging camera 30 is connected to the viewpoint position deriving device 34 so as to be able to communicate therewith.

The seated position detecting sensor 32 of the driver monitoring system 20 is, as an example, provided (see FIG. 1) at an unillustrated slide rail that makes it possible for a vehicle seat 54 of the driver to move with respect to a floor 56, and detects the position of the vehicle seat 54 with respect to the floor 56. The seated position detecting sensor 32 is connected to the viewpoint position deriving device 34 so as to be able to communicate therewith.

The CPU 36, a ROM 60, the RAM 40 and a storage 62 are provided at the interior of the viewpoint position deriving device 34 of the driver monitoring system 20. These respective structures are connected via a bus 64 so as to be able to communicate with one another. The CPU 36 reads-out programs from the ROM 60 or the storage 62, and executes the programs by using the RAM 40 as a workspace. In the present embodiment, a viewpoint position detecting program, which derives the viewpoint position of the vehicle occupant who is seated in the driver's seat, is stored in the ROM 60 or the storage 62. The ROM 60 stores various programs and various data. The storage 62 is structured by an HDD or an SSD, and stores various programs including the operating system, and various data.

(Functional Structures)

At the time when the aforementioned image processing program and viewpoint position detecting program are executed, the image display device 10 realizes various functions by using the above-described hardware resources. The functional structures that are realized by the image display device 10 are described.

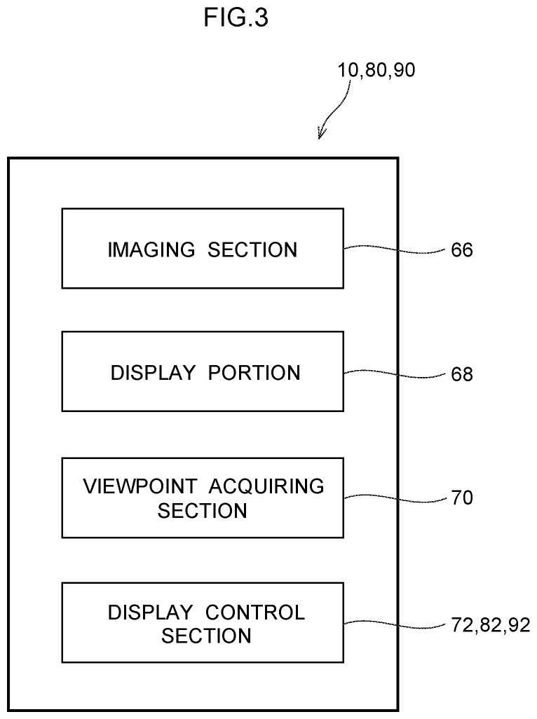

FIG. 3 is a block drawing showing an example of the functional structures of the image display device 10.

As shown in FIG. 3, the image display device 10 has, as the functional structures thereof, an imaging section 66, a display portion 68, a viewpoint position acquiring section 70, and a display control section 72 that serves as display controlling means. These respective functional structures are realized by the CPUs 36 of the display control device 18 and the viewpoint position deriving device 34 reading-out the image processing program and the viewpoint position detecting program that are stored in the ROM 38, 60 or in the storage 42, 62 (see FIG. 2), and executing the programs.

The imaging section 66 captures images of portions of the periphery of the vehicle 12 by the camera unit 14, and outputs the captured images to the display control section 72.

The display portion 68 outputs, to the electronic inner mirror 16, the image that is obtained by the images, which were captured by the imaging section 66, being subjected to image processing by the display control section 72. Note that details of the image processing of the display control section 72 are described later.

The viewpoint position acquiring section 70 derives the viewpoint position of the vehicle occupant by the viewpoint position deriving device 34 on the basis of position information of the eyes of the vehicle occupant that is acquired by the driver imaging camera 30 of the driver monitoring system 20, and seated position information of the vehicle occupant that is estimated from the position information of the vehicle seat 54 acquired by the seated position detecting sensor 32.

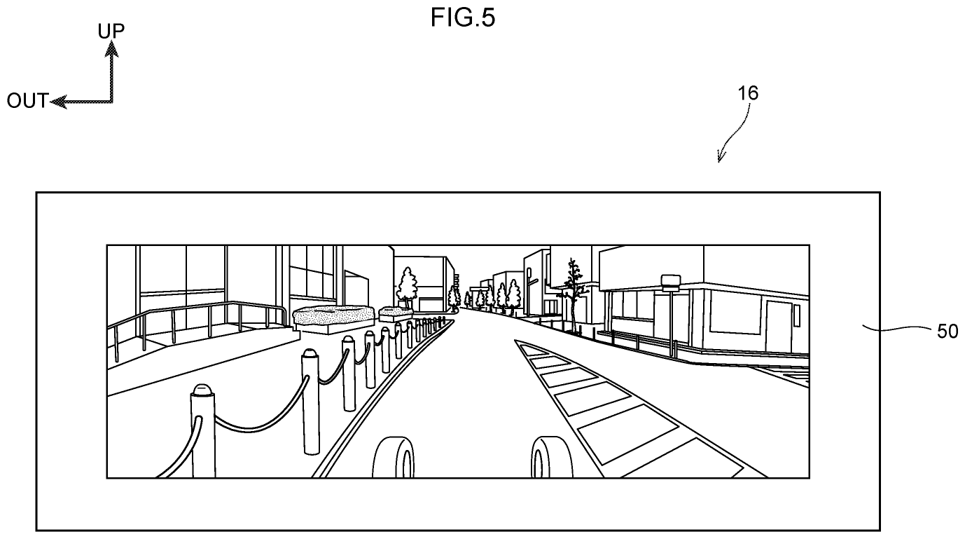

The display control section 72 changes the display position in accordance with the viewpoint position of the vehicle occupant that is acquired by the viewpoint position acquiring section 70, and outputs the image captured by the imaging section 66 to the electronic inner mirror 16. Namely, at the time when it is judged that the viewpoint position of the vehicle occupant substantially directly faces the electronic inner mirror 16, as shown in FIG. 5, the image is displayed in the substantially central portion, in the vertical direction and the left-right direction, of the image displayable region 50 of the electronic inner mirror 16.

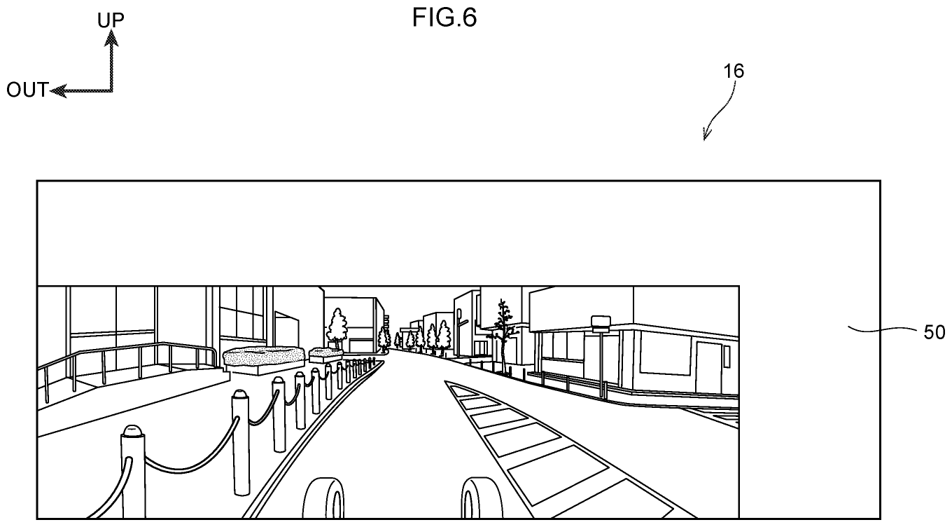

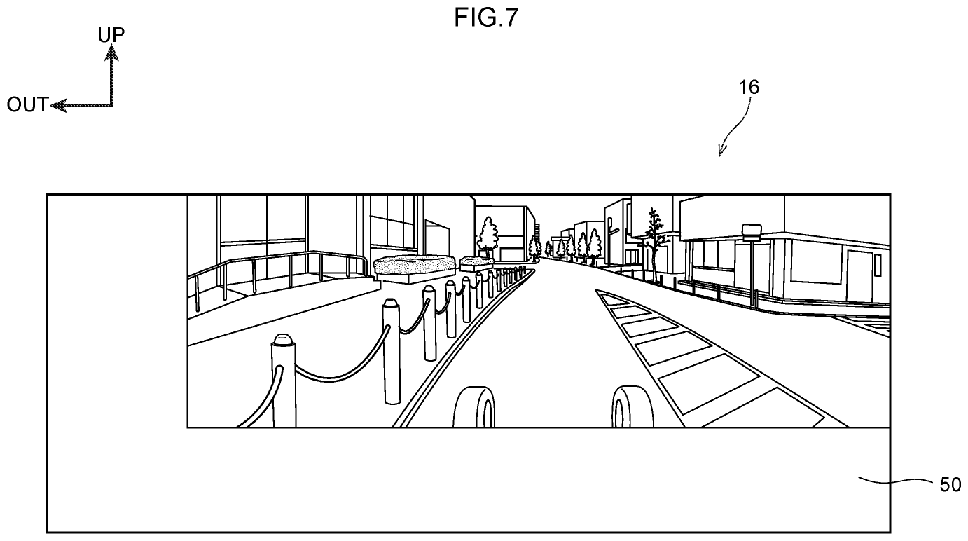

On the other hand, in a case in which the viewpoint position of the vehicle occupant is not substantially directly facing the electronic inner mirror 16, the display control section 72 changes the display position of the image at the image displayable region 50 in accordance with the viewpoint position. Namely, in a case in which the viewpoint position of the vehicle occupant is at the upper right with respect to directly facing the electronic inner mirror 16 (is at the upper left with respect to the electronic inner mirror 16 as seen in a vehicle front view), as shown in FIG. 4, generally, the portions, which are at the upper portion and the right side in the image displayable region 50 as seen from the vehicle cabin side, are blocked by the housing 48. Accordingly, as shown in FIG. 6, the display control section 72 moves the image toward the left side and the lower side in the image displayable region 50 of the electronic inner mirror 16 as seen from the vehicle cabin side, and displays the image. Further, in a case in which the viewpoint position of the vehicle occupant is at the lower left with respect to directly facing the electronic inner mirror 16 (is at the lower right with respect to the electronic inner mirror 16 as seen in a vehicle front view), although not illustrated, generally, the portions, which are at the lower portion and the left side in the image displayable region 50 as seen from the vehicle cabin side, are blocked by the housing 48. Accordingly, as shown in FIG. 7, the display control section 72 moves the image toward the right side and the upper side in the image displayable region 50 of the electronic inner mirror 16 as seen from the vehicle cabin side, and displays the image. Due thereto, at the time when an image is viewed in a state in which the viewpoint position is changed from a position directly facing the electronic inner mirror 16, even if regions of the image displayable region 50 that are blocked by the housing 48 arise, the amount of the image that is blocked can be made to be small.

(Operation/Effects of First Embodiment)

Operation and effects of the present embodiment are described next.

In the present embodiment, as shown in FIG. 2, the image display device 10 has the electronic inner mirror 16, the driver monitoring system 20, and the display control device 18. The electronic inner mirror 16 is provided within the vehicle cabin 46, and can display an image within the image displayable region 50. The driver monitoring system 20 acquires the viewpoint position of the vehicle occupant who views the electronic inner mirror 16. The display controlling means carries out image processing so as to change the displayed position of the image within the image displayable region 50 of the electronic inner mirror 16, in accordance with the viewpoint position of the vehicle occupant acquired by the driver monitoring system 20. Accordingly, in a case in which it is supposed that the image is being viewed in a manner of overlapping an obstacle to viewing due to the viewpoint position of the vehicle occupant, the displayed position of the image can be changed to a position at which the image does not overlap the obstacle to viewing. Due thereto, the visibility can be improved.

Further, the display control device 18 carries out image processing of the image that is acquired from the imaging means that captures images of the periphery of the vehicle. Therefore, the vehicle occupant can see an image, which shows the situation at the periphery of the vehicle 12 that is important at the time of driving, without the image being blocked by an obstacle to viewing. Due thereto, safe driving can be assisted.

Moreover, the electronic inner mirror 16 displays at least a portion of the image as a virtual image. Therefore, fluctuations in the focal length between the time when the image that is a virtual image of the electronic inner mirror 16 is viewed, and the time when the front side in the traveling direction is viewed, are suppressed, and the burden on the vehicle occupant at the time of viewing can be reduced. Further, at the electronic inner mirror 16 that displays the virtual image, generally, the virtual image can be seen by peering into the housing 48. Namely, depending on the viewpoint position of the vehicle occupant, there is the possibility that the housing 48 will become an obstacle to viewing, and the image that is the virtual image will not be able to be seen. However, in the image display device of the present embodiment, in a case in which it is supposed that the image will be viewed in a manner of overlapping with the housing 48 due to the viewpoint position of the vehicle occupant, the displayed position of the image can be changed to a position that does not overlap the housing 48. Due thereto, the visibility can be improved while the burden on the vehicle occupant is reduced.

### Second Embodiment

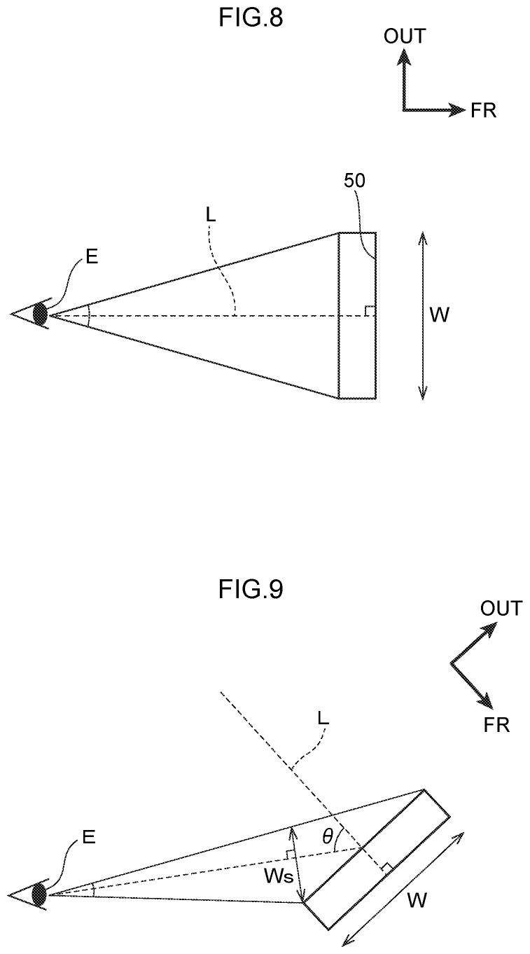

An image display device relating to a second embodiment of the present invention is described next by using FIG. 3, and FIG. 8 through FIG. 10. Note that structural portions that are the same as those of the above-described first embodiment the like are denoted by the same reference numerals, and description thereof is omitted.

The basic structure of an image display device 80 relating to the second embodiment is similar to that of the first embodiment, and the image display device 80 has the feature that the image is displayed in an enlarged manner in accordance with the viewpoint position of the vehicle occupant.

(Functional Structures)

Namely, as shown in FIG. 3, the image display device 80 has, as the functional structures thereof, the imaging section 66, the display portion 68, the viewpoint position acquiring section 70, and a display control section 82. These respective functional structures are realized by the CPUs 36 of the display control device 18 and the viewpoint position deriving device 34 reading-out the image processing program and the viewpoint position detecting program that are stored in the ROM 38, 60 or in the storage 42, 62 (see FIG. 2), and executing the programs.

The display control section 82 changes the display position and the display magnification at which the image is displayed in an enlarged manner, in accordance with the viewpoint position of the vehicle occupant acquired by the viewpoint position acquiring section 70, and outputs the image captured by the imaging section 66 to the electronic inner mirror 16. Namely, at the time when it is judged that the viewpoint position of the vehicle occupant substantially directly faces the electronic inner mirror 16, the image is displayed in the substantially central portion, in the vertical direction and the left-right direction, of the image displayable region 50 of the electronic inner mirror 16, and at a display magnification of 1× as an example (see FIG. 5). Note that, as shown in FIG. 8, in this case, eyes E of the vehicle occupant are positioned on normal line L of the image displayable region 50 of the electronic inner mirror 16. Further, the width of the image displayable region 50 is seen as W.

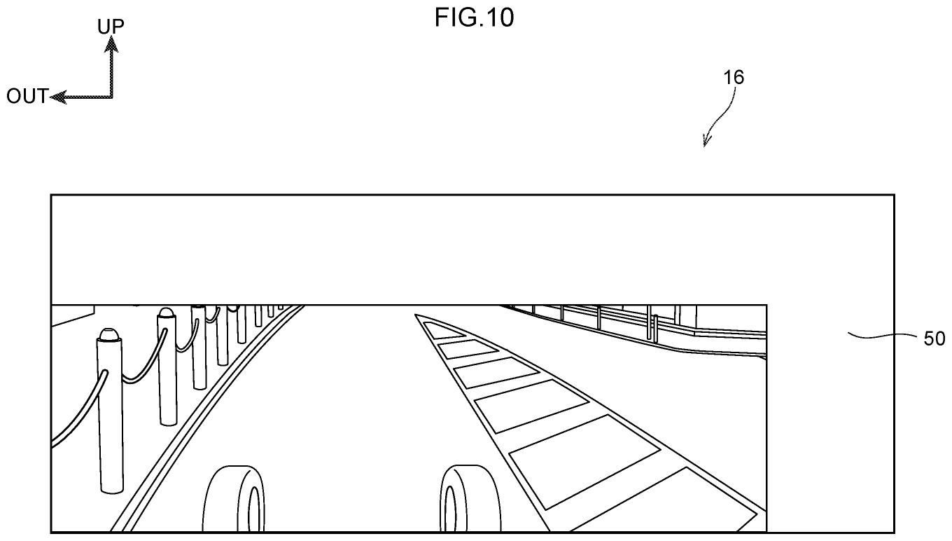

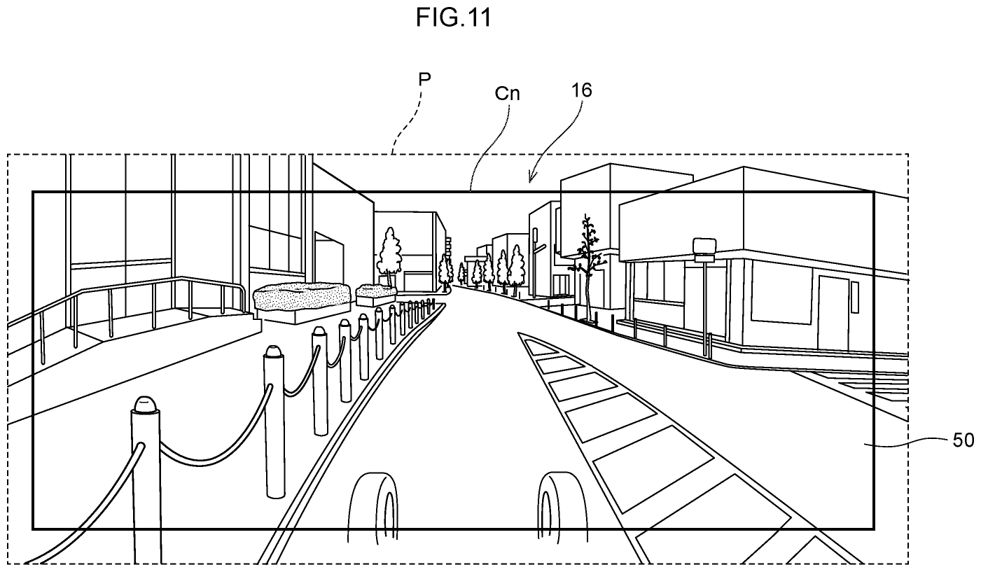

On the other hand, as shown in FIG. 9, in a case in which the eyes E of the vehicle occupant are positioned at an incline of a predetermined angle θ with respect to the normal line L, the width of the image displayable region 50 is seen as Ws. Namely, in a case in which the viewpoint position of the vehicle occupant is at a position that does not substantially directly face the electronic inner mirror 16, the image that is displayed in the image displayable region 50 is seen to be smaller. Accordingly, in a case in which the viewpoint position of the vehicle occupant is at a position that does not substantially directly face the electronic inner mirror 16, as shown in FIG. 10, the display control section 82, in accordance with the angle θ, changes the display magnification to greater than or equal to 1× in order for the image to be able to be seen at substantially the same size as it would if viewed when faced directly, and the display control section 82 moves the image to a position at which the amount in the image displayable region 50 that is blocked by the housing 48 is smaller.

(Operation/Effects of Second Embodiment)

Operation and effects of the second embodiment are described next.

In accordance with the above-described structure as well, effects that are similar to those of the first embodiment are obtained because the image display device 80 is structured similarly to the image display device 10 of the first embodiment, except for the point that the image is displayed in an enlarged manner in accordance with the viewpoint position of the vehicle occupant. Further, the display control section 82 changes the display magnification at which the image is displayed in an enlarged manner in accordance with the viewpoint position of the vehicle occupant that is acquired by the driver monitoring system 20. Accordingly, depending on the viewpoint position, there are cases in which the image is seen as smaller than in a case in which the image is viewed when faced directly, but, in such cases, by changing the display magnification of the image, the size of the image when viewed can be made to be substantially constant, regardless of the viewpoint position. Due thereto, the visibility can be improved further.

### Third Embodiment

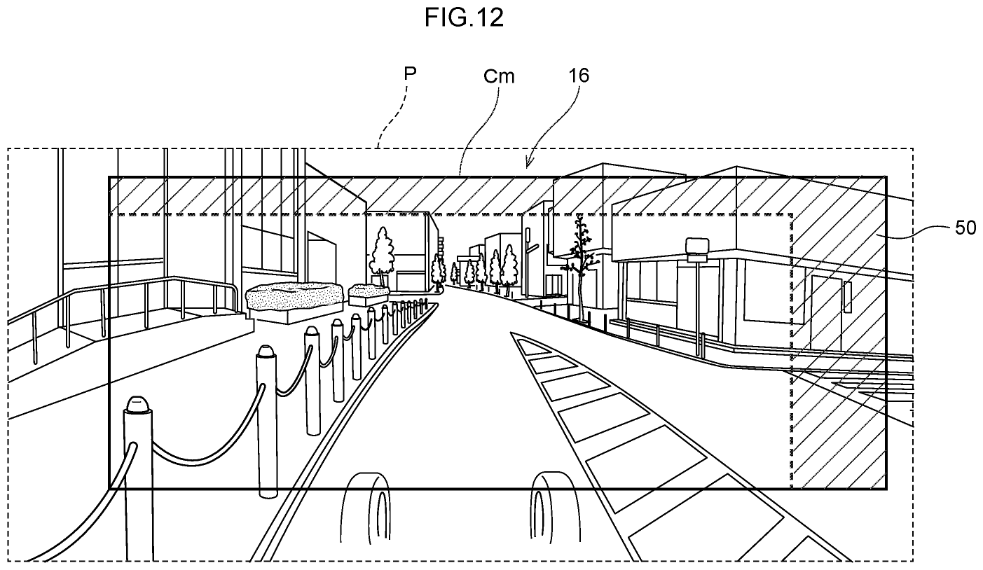

An image display device relating to a third embodiment of the present invention is described next by using FIG. 11 and FIG. 12. Note that structural portions that are the same as those of the above-described first embodiment the like are denoted by the same reference numerals, and description thereof is omitted.

The basic structure of an image display device 90 relating to the third embodiment is similar to that of the first embodiment, and the image display device 90 has the feature that a cut-out image, which is obtained by cutting-out a portion of the image, is displayed in the image displayable region 50 of the electronic inner mirror 16.

(Functional Structures)

Namely, as shown in FIG. 3, the image display device 90 has, as the functional structures thereof, the imaging section 66, the display portion 68, the viewpoint position acquiring section 70, and a display control section 92. These respective functional structures are realized by the CPUs 36 of the display control device 18 and the viewpoint position deriving device 34 reading-out the image processing program and the viewpoint position detecting program that are stored in the ROM 38, 60 or in the storage 42, 62 (see FIG. 2), and executing the programs.

The display control section 92 changes the cutting-out position of the image and the display magnification, in accordance with the viewpoint position of the vehicle occupant acquired by the viewpoint position acquiring section 70, and outputs the image captured by the imaging section 66 to the electronic inner mirror 16. Namely, at the time when it is judged that the viewpoint position of the vehicle occupant substantially directly faces the electronic inner mirror 16, as shown in FIG. 11, a standard cut-out image Cn, which is obtained by cutting-out the substantially central portion, in the vertical direction and the left-right direction, of an image P (refer to the dashed line in the drawing) captured by the imaging section 66, is displayed in the entire image displayable region 50 of the electronic inner mirror 16.

On the other hand, in a case in which the viewpoint position of the vehicle occupant is not substantially directly facing the electronic inner mirror 16, the display control section 92, in accordance with the viewpoint position, changes the cutting-out position in the image P captured by the imaging section 66. Namely, in a case in which the viewpoint position of the vehicle occupant is at the upper left with respect to the electronic inner mirror 16 as seen in a vehicle front view, generally, the portions, which are at the upper portion and the right side in the image displayable region 50 as seen from the vehicle cabin side, are blocked by the housing 48. Accordingly, as shown in FIG. 12, the display control section 82 displays, on the entire image displayable region 50 of the electronic inner mirror 16, cut-out image Cm that has been cut-out with the display magnification changed in accordance with the viewpoint position, and at a position at which the central portion of the region (i.e., the region that the vehicle occupant can see, refer to the dotted line in the drawing) other than the range in the image displayable region 50 that is blocked by the housing 48 (refer to the hatched portion in the drawing) becomes the same as the central portion of the image P captured by the imaging section 66. Note that, although not illustrated, also in cases in which the viewpoint position of the vehicle occupant does not substantially directly face the electronic inner mirror 16 and is at other than the upper left with respect to the electronic inner mirror 16 as seen in a vehicle front view, as described above, the cut-out image Cm that is cut-out with the display magnification changed in accordance with the viewpoint position, and at a position at which the central portion of the region other than the range blocked by the housing 48 becomes the same as the central portion of the image P captured by the imaging section 66, is displayed in the entire image displayable region 50 of the electronic inner mirror 16.

(Operation/Effects of Third Embodiment)

Operation and effects of the third embodiment are described next.

In accordance with the above-described structure as well, effects that are similar to those of the first embodiment are obtained because the image display device 90 is structured similarly to the image display device 10 of the first embodiment, except for the point that the cut-out image, which is obtained by a portion of the image being cut-out, is displayed in the image displayable region 50 of the electronic inner mirror 16. Further, the display control section 92 carries out image processing so as to, in accordance with the viewpoint position of the vehicle occupant acquired by the driver monitoring system 20, change the cutting-out position at the time of cutting-out a portion of the image and displaying on the electronic inner mirror 16. Accordingly, in a case in which it is supposed that the image is being viewed in a manner of overlapping an obstacle to viewing due to the viewpoint position of the vehicle occupant, changing of the cutting-out position can be carried out, and the like, such that highly-important information (in the case of the present embodiment, the central portion of the image P that corresponds to the rear of the vehicle 12) is not displayed at a region that overlaps an obstacle to viewing in the image. Due thereto, the visibility can be improved.

Moreover, the cut-out image Cn, Cm is displayed in the entire image displayable region 50 of the electronic inner mirror 16. Therefore, the vehicle occupant feeling a sense of incongruity due to margins of the image displayable region 50 being displayed can be reduced.

Note that the above-described third embodiment is structured such that the cutting-out position of the image P is changed in accordance with the viewpoint position of the vehicle occupant. However, the present disclosure is not limited to this, and may be structured such that, together therewith, the displayed position within the image displayable region 50 also is changed.

Further, although the above-described first through third embodiments are structured such that an image, in which a portion of the periphery of the vehicle 12 is captured, is displayed on the display portion 68, the present disclosure is not limited to this, and may be structured so as to display another image such as displayed contents of a car navigation system or the like.

Moreover, the display portion 68 is structured so as to display an image by the electronic inner mirror 16 that displays a virtual image, but the present disclosure is not limited to this, and may be structured so as to display the image by another device, such as a display device or the like that is provided at the instrument panel 52. Still further, although the images displayed by the electronic inner mirror 16 all are virtual images, the present disclosure is not limited to this, and may be structured so as to display images of which only some are virtual images, or may be structured so as to display images that are all actual images. Further, although the visual obstacle is the housing 48, the present disclosure is not limited to this, and the visual obstacle may be another member that is provided in the vicinity of the display device, such as the instrument panel 52 or the like.

Moreover, the viewpoint position deriving device 34 is structured so as to derive the viewpoint position of the vehicle occupant on the basis of position information of the eyes of the vehicle occupant that is acquired by the driver imaging camera 30, and seated position information of the vehicle occupant that is estimated from the position information of the vehicle seat 54 that is acquired by the seated position detecting sensor 32. However, the present disclosure is not limited to this. There may be a structure in which a sensor is provided that senses body weight by using the property that the body weight of a human and the seat height have a substantially constant relationship, and the viewpoint position is estimated from the body weight information of the vehicle occupant that is obtained from this sensor. Other than this, there may be a structure in which the viewpoint of the vehicle occupant is derived by using an infrared sensor, or a combination of various types of sensors, or the like.

Although embodiments of the present invention have been described above, embodiments are not limited to those described above, and the present invention can, of course, be implemented by being modified in various ways other than the above within a scope that does not depart from the gist thereof.

What is claimed is:

1. An image display device comprising:
a display that is provided within a vehicle cabin, and enables display of an image within an image displayable region;
a driver monitoring system that acquires a viewpoint position of a vehicle occupant who views the display; and
display controlling device including a first processor that is configured to carry out image processing so as to, in accordance with the viewpoint position of the vehicle occupant acquired by the driver monitoring system, change at least one of a displayed position of the image within the image displayable region of the display, and a cutting-out position of the image at a time of cutting-out a portion of the image and displaying on the display.

2. The image display device of claim 1, wherein the first processor of the display controlling device is configured to carry out image processing of the image that is acquired from a first camera that captures images of a periphery of the vehicle.

3. The image display device of claim 1, wherein the display displays at least a portion of the image as a virtual image.

4. The image display device of claim 2, wherein the display displays at least a portion of the image as a virtual image.

5. The image display device of claim 1, wherein the first processor of the display controlling device is configured to change a display magnification at which the image is displayed in an enlarged manner, in accordance with the viewpoint position of the vehicle occupant acquired by the driver monitoring system.

6. The image display device of claim 2, wherein the first processor of the display controlling device is configured to change a display magnification at which the image is displayed in an enlarged manner, in accordance with the viewpoint position of the vehicle occupant acquired by the driver monitoring system.

7. The image display device of claim 3, wherein the first processor of the display controlling device is configured to change a display magnification at which the image is displayed in an enlarged manner, in accordance with the viewpoint position of the vehicle occupant acquired by the driver monitoring system.

8. The image display device of claim 4, wherein the first processor of the display controlling device is configured to change a display magnification at which the image is displayed in an enlarged manner, in accordance with the viewpoint position of the vehicle occupant acquired by the driver monitoring system.

9. The image display device of claim 1, wherein the driver monitoring system comprises:
a second camera that acquires position information of eyes of the vehicle occupant;
a sensor that acquires position information of a vehicle seat;
a second processor that is configured to derive the viewpoint position of the vehicle occupant on the basis of the position information of the eyes of the vehicle occupant that is acquired by the second camera, and seated position information of the vehicle occupant that is estimated from the position information of the vehicle seat acquired by the sensor.
